(19) United States
(12) Patent Application Publication
(10) Pub. No.: US 2026/0036033 A1
(43) Pub. Date: Feb. 5, 2026

(54) IDENTIFYING BREAKOVER EVENTS USING RIG SENSOR MEASUREMENTS WITH ASSOCIATED RIG STATE DETERMINATION

(71) Applicant: Schlumberger Technology Corporation, Sugar Land, TX (US)

(72) Inventors: James Philip Belaskie, Houston, TX (US); Riley Foster, Houston, TX (US); Ricardo Quirch, Katy, TX (US); Xianxiang Huang, Houston, TX (US); Brennan Daniel Goodkey, Sugar Land, TX (US)

(21) Appl. No.: 18/789,735

(22) Filed: Jul. 31, 2024

(51) Int. Cl. E21B 44/00

(52) U.S. Cl. CPC E21B 44/00; G01M 5/0041

(57) ABSTRACT

A breakover management system may monitor, with a monitoring frequency, a rig sensor data stream to identify a rig state of the drill rig, the rig sensor data stream having a measurement frequency greater than the monitoring frequency. A breakover management system may store the rig sensor data stream in a cache for a cache period. A breakover management system may, when the rig state includes a movement state after a static state, retrieve the rig sensor data stream from a cache for the cache period. A breakover management system may identify, based on an analysis frequency of the rig sensor data stream, a breakover profile of a breakover event experienced by the drill rig, the analysis frequency greater than the monitoring frequency.

### BACKGROUND OF THE DISCLOSURE

Drilling is used to access subterranean formations for exploration, the extraction of natural resources (e.g., oil, natural gas, water), power generation, other uses, and combinations thereof. A downhole drilling system includes a bit that is connected to a drill string and/or other downhole tools. During drilling activities, the drill string experiences forces based on the weight of the drill string, the upward force applied to the drill string, the torque applied to the drill string, and so forth. In some situations, the drill string may experience a sticking event that may increase the forces used to move the drill string. The drilling system may unstick the drilling system in a breakover event when the force applied to the drill string overcomes the sticking force.

### SUMMARY

In some aspects, the techniques described herein relate to a method for identifying a breakover event of a drill rig. A breakover management system may monitor, with a monitoring frequency, a rig sensor data stream to identify a rig state of the drill rig. The rig sensor data stream has a measurement frequency greater than the monitoring frequency. The breakover management system stores the rig sensor data stream in a cache for a cache period. When the rig state includes a movement state after a static state, the breakover management system retrieves the rig sensor data stream from a cache for the cache period. The breakover management system identifies, based on an analysis frequency of the rig sensor data stream, a breakover profile of a breakover event experienced by the drill rig. The analysis frequency is greater than the monitoring frequency.

In some aspects, the techniques described herein relate to a method for identifying a breakover event of a drill rig. A breakover management system receives a lower frequency rig sensor data stream of the drill rig sufficient to identify motion changes. The low frequency rig sensor data stream includes rig sensor measurements with associated rig state determination of the drill rig. The low frequency rig sensor data stream has a monitoring frequency. The breakover management system identifies a rig state of the drill rig from the low frequency rig sensor data stream. The rig state including a movement state. When the movement state includes movement after a static state, the breakover management system retrieves a high frequency rig sensor data stream of the drill rig from a cache. The high frequency rig sensor data stream has an analysis frequency that is greater than the monitoring frequency. The breakover management system identifies, based on the high frequency rig sensor data stream, a breakover profile to identify the breakover event.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system, according to at least one embodiment of the present disclosure.

FIG. 2 is a representation of a breakover management system, according to at least one embodiment of the present disclosure.

FIG. 3-1 through FIG. 3-4 are representations of breakover profiles for the four identified movement states of a breakover event, according to at least one embodiment of the present disclosure.

FIG. 4 is a schematic representation of a breakover management system, according to at least one embodiment of the present disclosure.

FIG. 5 is a flowchart of a method for identifying a breakover event, according to at least one embodiment of the present disclosure.

FIG. 6 is a flowchart of a method for identifying a breakover event, according to at least one embodiment of the present disclosure.

FIG. 7 is a flowchart of a method for identifying a breakover event, according to at least one embodiment of the present disclosure.

FIG. 8 is a flowchart of a method for identifying a breakover event, according to at least one embodiment of the present disclosure.

FIG. 9 illustrates certain components that may be included within a computer system 900.

### DETAILED DESCRIPTION

This disclosure generally relates to devices, systems, and methods for identifying and/or classifying a breakover event experienced by a drill rig. A breakover event occurs when a drill rig begins movement after being motionless for a period of time. For example, during a drilling operation, portions of the drilling system may become stuck, including the bit, a bottom hole assembly (BHA), a downhole tool, the drill pipe, any other portion of the drilling system, and combinations thereof. Breakover events may result in a sudden change in torque or hookload that reverberates through the drill string. For example, the change in torque or hookload may cause a cyclic increase and decrease in the torque or hookload.

A breakover event is identified based on a breakover profile of rig sensor measurements with associated rig state determination. For example, the rig sensor measurements with associated rig state determination may identify a cyclic pattern of the rig sensor measurements with associated rig state determination including a high peak or low trough in the measurement, followed by a large swing to a low trough or high peak. The frequency of the cyclic changes in rig sensor measurements with associated rig state determination may be based on the length of the drill string. For example, the wavelength (e.g., the distance between peaks and/or troughs) of vibratory and/or oscillatory motion may increase based on the length of the vibrating or oscillating elements. For a drilling system, the frequency vibratory and/or oscillatory motion may be based on the length of the drill string. For example, a relatively longer drill string may result in a longer wavelength of motion, and a relatively shorter drill string may result in a shorter wavelength of motion.

Conventionally, rig state is monitored and calculated based on a low-frequency data stream of rig sensor measurements with associated rig state determination. Processing resources and/or transmission bandwidth at a wellbore may be limited, and a low-frequency rig sensor data stream is used to reduce the processing and/or transmission load on the rig site, thereby allowing timely calculation of the rig state. But a low-frequency rig sensor data stream may not allow the operator to timely calculate the rig state, and therefore identify the occurrence of a breakover event. For example, the frequency of the rig sensor data stream may not provide sufficient data points (or may provide data points with insufficient resolution) in the breakover profile to identify the peak and/or trough of the breakover profile. This may result in a failure to identify a breakover event, or a failure to accurately classify the severity of the breakover event. Further, the rig site computing system may have insufficient computing resources to monitor a high-frequency rig sensor data stream.

In accordance with at least one embodiment of the present disclosure, a breakover management system may monitor the rig state of the drill rig using a low-frequency rig sensor data stream. When the breakover management system identifies that the drill rig has moved after being has been motionless for a period of time, the breakover management system may identify whether a breakover event occurred using a high-frequency rig sensor data stream. Monitoring the rig state using the low frequency rig sensor data stream may reduce the processing load on the rig site computing system and/or the transmission bandwidth to a remote computing system. The high frequency rig sensor data stream may provide sufficient measurement frequency and/or resolution to identify the peaks and/or troughs of a breakover profile of the breakover event. Further, the high frequency rig sensor data stream may be identified in the appropriate direction for the motion type. In some embodiments, the high frequency rig sensor data stream(s) used for analysis may be identified by the motion type(s). In this manner, the breakover management system may reliably identify breakover events while reducing the processing load on the rig site computing system.

As illustrated by the foregoing discussion, the present disclosure utilizes a variety of terms to describe features and advantages of the breakover management system. Additional detail is now provided regarding the meaning of such terms. For example, as used herein, the term “breakover” or “breakover event” refers to a sudden increase in the forces on the drill string following a period of non-motion (e.g., motionlessness). In particular, a breakover event may include the vibratory and/or oscillatory pattern experienced by the drill string after a period of non-motion. Physically, when the drill string is stuck in the wellbore, the drill rig applies a greater force to release the stuck portion(s) of the drill string. A breakover event occurs at the time of release of the drill string from the wellbore.

The energy released at the time of the breakover is at least partially transferred up the drill string to the surface. The breakover event is characterized by parameters measured at the surface location. For example, the measured parameters may exhibit a breakover profile. The breakover profile may be the pattern of the measured parameters based on the energy transferred to the surface through the drill string. The breakover profile may provide an indication of the extent of the sticking of the drill string and/or the type of sticking experienced by the drill string.

As used herein, the term “rig state” may refer to the mode in which the drill rig is operated. For example, Rig activity may be broken down into a number of processes, such as drilling in rotary mode, drilling in slide mode, run-in-hole (RIH), pull out of hole (POOH), and so forth, that are controlled by the driller. The rig state may be identified based on multiple measurements, including one or more of block position, hookload, torque, and standpipe pressure. In some embodiments, the inputs to the rig state may include an in slips status based on hookload, an on bottom status based on bit depth and hole depth, a rotation status based on surface torque or rotational rate or MWD collar rotational rate and frame flag, a pumping status based on stand pipe pressure or pump status, and an axial motion based on block velocity or block position of the traveling block. Based on these input channels, the rig state detection system may identify or detects the rig state of the drilling rig. The rig state may include the current operation. In some embodiments, the rig state may include the hole depth.

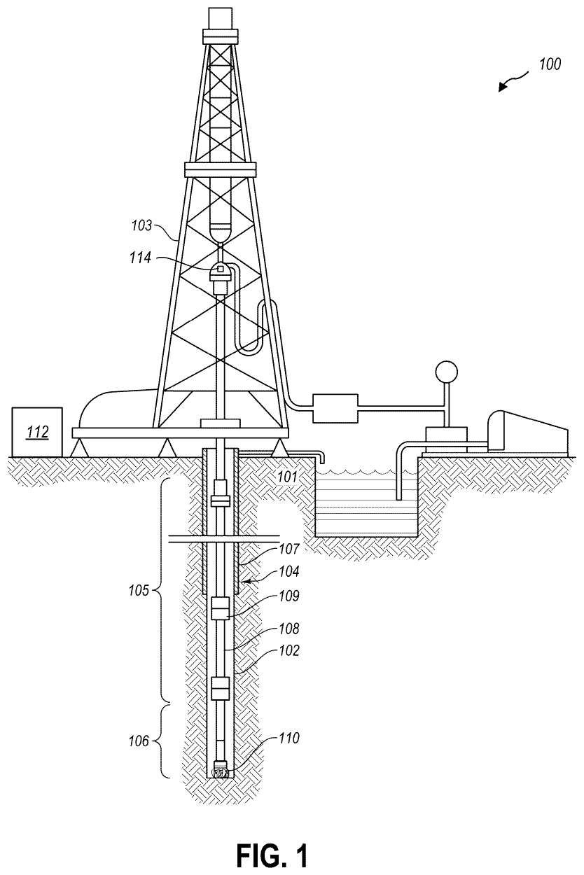

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

During operation of the drilling system 100, portions of the drilling system 100 may become stuck in the wellbore 102, such as the bit 110, the BHA 106, the drill string 105, the drilling tool assembly 104, or any other element of the drilling system 100. When the portions of the drilling system 100 are stuck, the drilling system 100 may continue to apply forces to the drill string 105, including forces that are greater than the steady-state operating forces. When the drilling system 100 becomes unstuck, these forces may cause vibration or oscillations within the drill string 105.

A breakover management system 112 may receive a rig sensor data stream from one or more sensors 114. The sensors 114 may include any type of sensors, including a block position sensor, a hookload sensor (e.g., that measures the weight of the drill string 105 and the BHA 106 supported by the drill rig 103), a torque sensor (e.g., that measures the torque applied to the drill string 105), a standpipe pressure sensor (e.g., that measures the pressure of the drilling fluid flowed through the drill string 105), any other rig sensor, and combinations thereof.

The breakover management system 112 may use the rig sensor data stream to identify the rig state of the drilling system 100. For example, the rig state may include one of drill rotation, drill slide, RIH pumping and rotation, RIH and pumping, RIH, POOH pumping and rotation, POOH and pumping, POOH, static pumping and rotation, static and pumping, static, in slips, uncategorized, any other rig state, and combinations thereof.

A breakover event may occur when the rig state changes from static (or non-moving) to a mobile state. Breakover events may occur based on one of four primary movement types, including first movement up (e.g., the first movement after the static rig state is a movement upward), first movement down (e.g., the first movement after the static rig state is a movement downward), first movement rotation (e.g., the first movement after the static rig state is a rotational movement), and first movement up followed immediately by a movement down (e.g., the first movement after the static rig state is a movement upward immediately followed by a movement downward).

The breakover event may be characterized by a breakover profile. The breakover profile may be a time-series pattern of the rig state following the static state. The breakover profile may change based on the breakover movement type. Further, the breakover profile may change based on the depth of the bit 110 (e.g., the total length of the drill string 105, the BHA 106, and the bit 110). For example, a relatively deeper hole depth may cause vibrations and oscillations having a greater wavelength, and a relatively shallower hole depth may cause vibrations and oscillations having a smaller wavelength.

Conventionally, the breakover management system 112 may monitor the rig state with a monitoring frequency. The monitoring frequency may be based on the processing capacity of the breakover management system 112, as well as the response capacity of the drilling system 100. In some embodiments, the monitoring frequency may be in a range having an upper value, a lower value, or upper and lower values including any of 1.0 Hz, 1.5 Hz, 2.0 Hz, 3 Hz, 5 Hz, 10 Hz, 20 Hz, 30 Hz, 40 Hz, or any value therebetween. For example, the monitoring frequency may be greater than 1 Hz. In another example, the monitoring frequency may be less than 40 Hz. In yet other examples, the monitoring frequency may be any value in a range between 1 Hz and 40 Hz. In some embodiments, it may be critical that the monitoring frequency is between 1 Hz and 5 Hz to allow an operator to identify changes to the rig state with sufficient time to adjust the operating state of the drilling system 100.

Monitoring breakover events may allow an operator to adjust the operating parameters of the drilling system 100 to reduce the severity and/or prevent or reduce the occurrence of breakover events. But some breakover events may not be detected based on the measurement frequency. For example, at depths less than between 10,000 feet and 15,000 feet, the wavelength of vibrations and oscillations of the drill string 105 may be too short to reliably identify the peaks and troughs that form the breakover profile of the rig sensor data stream with low frequency sensor measurements. For example, during the time between measurements based on the measurement frequency, the peak or the trough may pass, which may cause a failure to identify a breakover event.

In accordance with at least one embodiment of the present disclosure, the breakover management system 112 may identify breakover events using rig sensor measurements with associated rig state determination having an analysis frequency that is greater than the monitoring frequency. In some embodiments, the analysis frequency may be in a range having an upper value, a lower value, or upper and lower values including any of 10 Hz, 15 Hz, 20 Hz, 25 Hz, 30 Hz, 40 Hz, 50 Hz, 60 Hz, 100 Hz, or any value therebetween. For example, the analysis frequency may be greater than 10 Hz. In another example, the analysis frequency may be less than 100 Hz. In yet other examples, the analysis frequency may be any value in a range between 10 Hz and 100 Hz. In some embodiments, it may be critical that the analysis frequency is between 20 Hz and 60 Hz to sufficiently identify breakover events experienced by the drilling system 100.

In accordance with at least one embodiment of the present disclosure, the breakover management system 112 may identify a potential breakover event based on a trigger event identified in the low-frequency rig sensor data stream. For example, the breakover management system 112 may monitor the rig state using the low-frequency rig sensor data stream having the monitoring frequency. The trigger event may include a static state for a static period followed by a movement state. The static period may be the amount of time over which the downhole elements of the drilling system 100 may be come. In some embodiments, the static period may be in a range having an upper value, a lower value, or upper and lower values including any of 5 s, 10 s, 15 s, 20 s, 25 s, 30 s, 35 s, 40 s, 45 s, 50 s, 55 s, 60 s, or any value therebetween. For example, the static period may be greater than 5 s. In another example, the static period may be less than 60 s. In yet other examples, the static period may be any value in a range between 5 s and 60 s. In some embodiments, it may be critical that the static period is between 25 s and 35 s to consistently identify when the downhole elements of the drilling system 100 become stuck.

When the breakover management system 112 identifies the trigger event, the breakover management system 112 may analyze the high-frequency rig sensor data stream at the analysis frequency to identify the breakover event. Using the high-frequency rig sensor data stream to identify the breakover event may increase the accuracy of breakover event identification. For example, the increased number of measurements may facilitate an improved resolution of the breakover profile. This may increase the accuracy of the identified peaks and/or troughs of the breakover profile. In this manner, the breakover management system 112 may identify breakover events that would not have been identified using the measurement frequency.

When the breakover management system 112 identifies one or more breakover events, the breakover management system 112 may adjust one or more drilling parameters of the drilling system 100, or prepare a recommendation to adjust one or more drilling parameters of the drilling system 100. For example, the breakover management system 112 may adjust or prepare a recommendation to adjust the weight on bit (WOB), the torque or rotational rate, adjust the drilling fluid density, adjust the drilling fluid composition, increase stabilization of the BHA, move the BHA out of the permeable zone, adjust the drilling fluid flow rate of the drilling system 100, and combinations thereof. Adjusting the WOB may adjust whether the bit 110, the drill string 105, and/or the BHA 106 may be pushed into the formation and get stuck. Adjusting the torque may adjust the force applied to the formation by the bit 110, the drill string 105, and/or the BHA 106. Adjusting the drilling fluid flow rate may adjust the wellbore cleaning capacity of the system, thereby reducing or preventing the buildup of cuttings or other material in the wellbore.

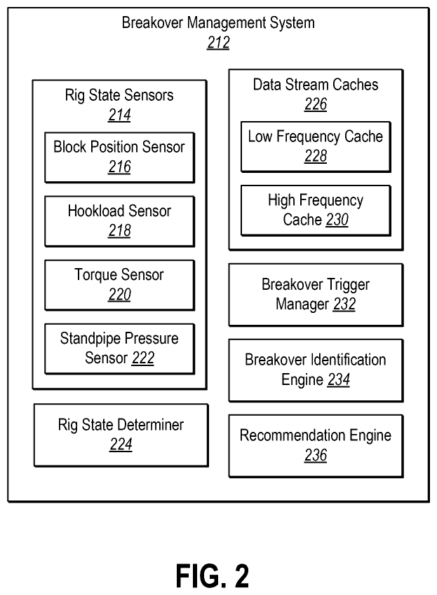

FIG. 2 is a representation of a breakover management system 212, according to at least one embodiment of the present disclosure. Each of the components of the breakover management system 212 can include software, hardware, or both. For example, the components can include one or more instructions stored on a computer-readable storage medium and executable by processors of one or more computing devices, such as a client device or server device. When executed by the one or more processors, the computer-executable instructions of the breakover management system 212 can cause the computing device(s) to perform the methods described herein. Alternatively, the components can include hardware, such as a special-purpose processing device to perform a certain function or group of functions. Alternatively, the components of the breakover management system 212 can include a combination of computer-executable instructions and hardware.

Furthermore, the components of the breakover management system 212 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

As discussed herein, the breakover management system 212 may identify a breakover event based on an input rig sensor data stream. For example, the breakover management system 212 may receive the rig sensor data stream from one or more rig sensors 214. The rig sensors 214 may include any sensor that may be used to determine the rig state. For example, the rig sensors 214 may include a block position sensor 216 that may sense the position of the travelling block of a drill rig. This may be used to determine how much drill pipe is in the wellbore and/or determine the total depth of the drill string. For example, the block position sensor 216 may include a count of the number of individual drill pipes inserted into the wellbore, as well as the position of the travelling block above the collar of the wellbore. In this manner, the breakover management system 212 may determine the length of the drill string in the wellbore. In some embodiments, the block position sensor 216 may identify the block position over the collar and another sensor or counter may include a count of the number of drill pipes in the wellbore.

The rig sensors 214 may further include a hookload sensor 218. The hookload sensor 218 may measure the weight of the drill string supported by the drill rig. In some embodiments, the drill rig may support the entire weight of the drill string. In some embodiments, the drill rig may support a portion of the weight of the drill string less than the entire weight based on friction between the drill string and the wellbore wall and/or the bottom of the wellbore supporting the bit. In some embodiments, the forces on the drill rig may be greater than the weight of the drill string, such as when tripping out of the wellbore. The hookload sensor 218 may measure the weight supported by the drill rig.

The rig sensors 214 may further include a torque sensor 220. The torque sensor 220 may measure the torque applied to the drill string during drilling operations. For example, the torque sensor 220 may be located on a turn table or a Kelly or a top drive and may measure the torque applied to the drill string. In some embodiments, the torque sensor 220 may measure the direction of the torque applied to the drill string.

The rig sensors 214 may include a standpipe pressure sensor 222. The standpipe pressure sensor 222 may measure the drilling fluid pressure of the drilling fluid pumped into the wellbore. The standpipe pressure sensor 222 may be located at the standpipe, or the conduit from the pumps to the drill pipe to introduce drilling fluid into the wellbore.

The rig sensors 214 may measure the rig state with a measurement frequency. The measurement frequency may be the rate at which the rig sensors 214 collect their respective measurements. In some embodiments, each of the rig sensors 214 measure with the same measurement frequency. In some embodiments, different rig sensors 214 measure with different measurement frequencies. In some embodiments, the measurement frequency may be in a range having an upper value, a lower value, or upper and lower values including any of 1 Hz, 5 Hz, 10 Hz, 15 Hz, 20 Hz, 25 Hz, 30 Hz, 40 Hz, 50 Hz, 60 Hz, 100 Hz, or any value therebetween. For example, the measurement frequency may be greater than 10 Hz. In another example, the measurement frequency may be less than 100 Hz. In yet other examples, the measurement frequency may be any value in a range between 10 Hz and 100 Hz. In some embodiments, it may be critical that the measurement frequency is between 20 Hz and 60 Hz to sufficiently identify breakover events experienced by the drilling system 100.

A rig state determiner 224 may receive the rig sensor data stream from the rig sensors 214 and identify the rig state of the drilling rig. In some embodiments, the rig state determiner 224 may identify a movement state. For example, the rig state determiner 224 may determine whether the rig is not moving (e.g., a static state). In some examples, the rig state determiner 224 may determine in which direction the drill rig is moving. This may facilitate an identification of the movement type after becoming unstuck, including first movement up, first movement down, first movement rotation, and first movement up followed immediately by a movement down.

The breakover management system 212 may direct the rig sensors 214 to one or more data stream caches 226. The data stream caches 226 may include a low frequency cache 228. The low frequency cache 228 may store low-frequency rig sensor measurements with associated rig state determination having the monitoring frequency, as discussed herein. In some embodiments, the rig state determiner 224 may determine and monitor the rig state based on the rig sensor measurements with associated rig state determination in the low frequency cache 228. This may facilitate quick and responsive determinations of the rig state.

The data stream caches 226 may further include a high frequency cache 230. The high frequency cache 230 may store high frequency rig sensor measurements with associated rig state determination. For example, the high frequency cache 230 may store rig sensor measurements with associated rig state determination with the analysis frequency. In some embodiments, the high frequency cache 230 may store the high-frequency data with the measurement frequency.

The data stream caches 226 may be a temporary storage for the rig sensor data stream. For example, the data stream caches 226 may store their respective data for a cache period. In some embodiments, the cache period may be in a range having an upper value, a lower value, or upper and lower values including any of 5 s, 10 s, 15 s, 20 s, 25 s, 30 s, or any value therebetween. For example, the cache period may be greater than 5 s. In another example, the cache period may be less than 30 s. In yet other examples, the cache period may be any value in a range between 5 s and 30 s. In some embodiments, it may be critical that the cache period is between 25 s and 30 s to retrieve the rig sensor measurements with associated rig state determination for an entire breakover event.

Temporarily storing the rig sensor measurements with associated rig state determination in the data stream caches 226 may facilitate a retroactive analysis of the rig sensor measurements with associated rig state determination based on the occurrence of a breakover event. For example, a breakover trigger manager 232 may receive rig sensor measurements with associated rig state determination. The breakover trigger manager 232 may identify the occurrence of a trigger event based on the rig sensor measurements with associated rig state determination, such as by identifying a movement state after a static state, as discussed herein.

When the breakover trigger manager 232 identifies a trigger event, a breakover identification and analysis engine 234 may analyze the rig sensor measurements with associated rig state determination to identify a breakover event. For example, the breakover identification and analysis engine 234 may retrieve the rig sensor measurements with associated rig state determination from the data stream caches 226. After retrieving the rig sensor measurements with associated rig state determination, the breakover identification and analysis engine 234 may analyze the rig sensor measurements with associated rig state determination to identify a breakover profile. If the breakover profile matches a known breakover profile, then the breakover identification and analysis engine 234 may identify the occurrence of a breakover event.

As discussed above, the breakover identification and analysis engine 234 may retrieve the cached rig sensor data stream from the data stream caches 226. For example, the breakover trigger manager 232 may identify the trigger event using the low frequency rig sensor data stream (either by directly identifying the rig state or indirectly through the rig states identified by the rig state determiner 224). As discussed herein, based on the length of the drill string in the wellbore, the low frequency rig sensor data stream may not provide sufficient resolution to consistently and accurately identify the occurrence of a breakover event. In accordance with at least one embodiment of the present disclosure, to increase the consistency of the breakover event identification, the breakover identification and analysis engine 234 may utilize the high frequency rig sensor data stream to identify the breakover event. The breakover identification and analysis engine 234 may retrieve the high frequency rig sensor data stream from the high frequency cache 230 to analyze the temporarily stored rig sensor data stream. In this manner, the breakover identification and analysis engine 234 may identify a breakover event using the high frequency rig sensor data stream without constantly monitoring the high frequency rig sensor data stream. In some embodiments, the breakover identification and analysis engine 234 may analyze the breakover profile using both the low frequency rig sensor data stream and the high frequency rig sensor data stream. In this manner, the breakover identification and analysis engine 234 may identify the increase in accuracy and/or consistency in breakover event identification resulting from utilizing the high frequency rig sensor data stream.

In accordance with at least one embodiment of the present disclosure, the breakover identification and analysis engine 234 may include a threshold alarm (e.g., threshold hookload or torque) that may be applied to the breakover force. Utilizing the threshold alarm may indicate that the BHA was held in static in a differential sticking zone. In some embodiments, the break over force is concentrated in the area around the BHA, and the alarm threshold may not need to be adjusted as the well gets deeper.

In some embodiments, the breakover identification and analysis engine 234 may identify a formation property of a differential sticking zone at a depth of the drill string. For example, the breakover identification and analysis engine 234 may identify a formation property associated with friction, sticking, mud generation, formation type, any other formation property, and combinations thereof.

In some embodiments, the breakover identification and analysis engine 234 may identify, based on the trigger event, no breakover, or low-magnitude breakover events. For example, not every trigger event may result in a breakover. When the breakover identification and analysis engine identifies no breakover events with a high confidence, this may indicate that the BHA is not experiencing differential sticking forces.

In some embodiments, the breakover identification and analysis engine 234 may prepare a confidence score for the breakover event. The confidence score may be based on the resolution of the rig sensor data stream with respect to the wavelength of the breakover event. For example, the confidence score may be based on the number of datapoints used to determine the breakover event (such as the number of datapoints in a half cycle, as discussed in further detail herein).

As discussed herein, the wavelength of the breakover profile may be based on the length of the drill string in the wellbore. The wavelength of the breakover profile may be identifiable based on the frequency of the rig sensor data stream. In some embodiments, the high frequency rig sensor data stream may have a variable analysis frequency. For example, the high frequency rig sensor data stream may have a shorter analysis frequency based on the length of the drill string. In some examples, the stored analysis frequency in the high frequency cache 230 may be reduced as the length of the drill string increases. In some embodiments, such as for drill strings having a length greater than 15,000 feet, the analysis frequency stored in the high frequency cache 230 may be the same as the analysis frequency stored in the low frequency cache 228.

In accordance with at least one embodiment of the present disclosure, a recommendation engine 236 may prepare a recommendation based on one or more identified breakover events. For example, the recommendation engine 236 may identify a pattern of multiple breakover events that occur at a particular location within the wellbore. Such patterns of breakover events may include a presence of or lack there of a differential sticking zone. The recommendation engine 236 may prepare a recommendation to change one or more drilling parameters to mitigate a breakover event or series of breakover events. For example, the recommendation engine 236 may prepare a recommendation to change the WOB, the torque or rotational rate, adjust the drilling fluid density, adjust the drilling fluid composition, increase stabilization of the BHA, move the BHA out of the permeable zone, adjust the drilling fluid flow rate of the drilling system 100, and combinations thereof. This may reduce the frequency of the occurrence of breakover events.

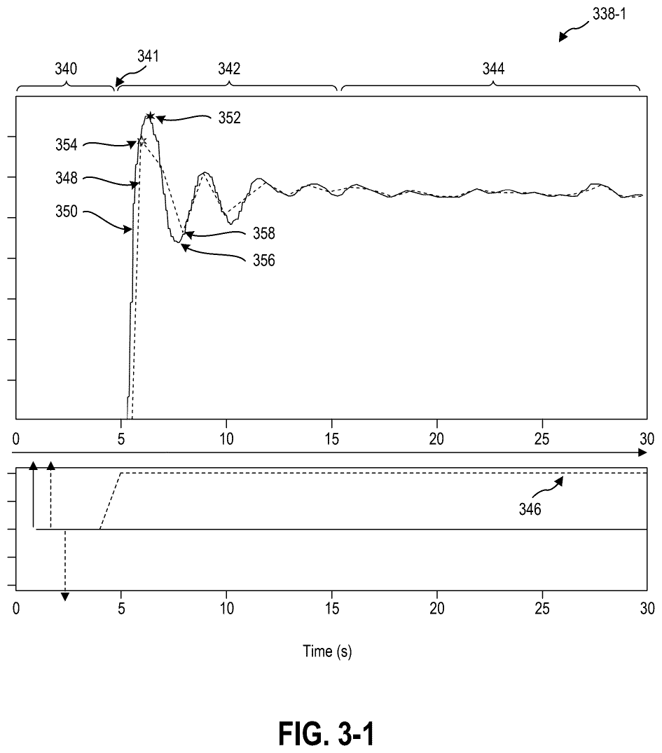

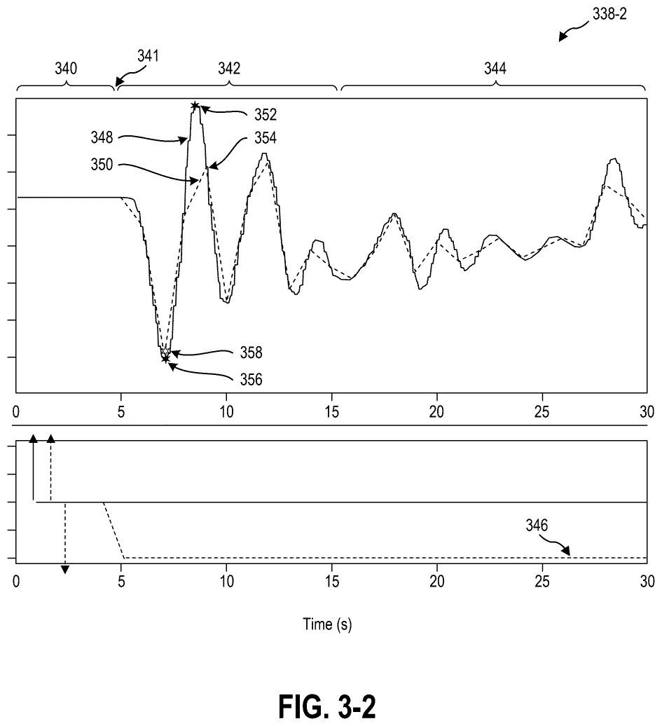

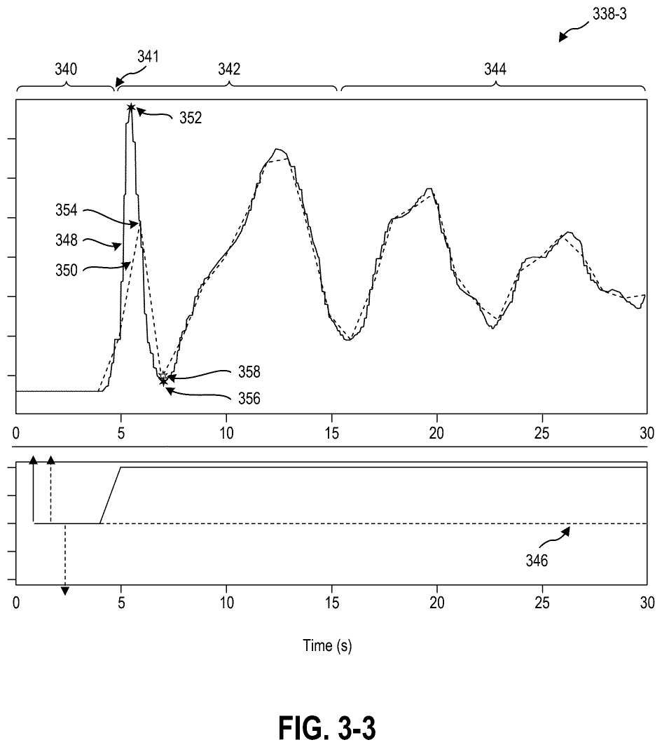

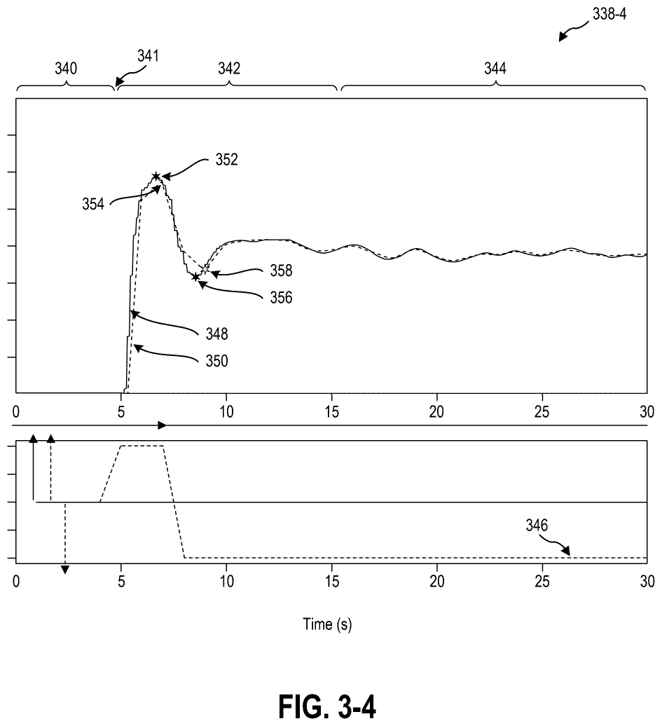

FIG. 3-1 through FIG. 3-4 are representations of breakover profiles for the four identified movement states of a breakover event, according to at least one embodiment of the present disclosure. For example, FIG. 3-1 is a representation of a first breakover profile 338-1 representing of a first upward movement state. In the first breakover profile 338-1 illustrated, in the static state 340, the drill string is not moving. At a trigger event 341, the drill string has experienced movement in a breakover event 342. After the breakover event 342, the drill string may enter steady state motion 344.

The movement state may be identified by a movement state plot 346. The movement state plot 346 may be a representation of the movement state of the drill rig. Based on the movement state, a breakover identification and analysis engine may identify the occurrence of a breakover event based on the breakover event 342 portion of the first breakover profile 338-1.

The first breakover profile 338-1 includes a high frequency plot 348 and a low frequency plot 350 of hookload. As may be seen, a high frequency peak 352 of the high frequency plot 348 in the breakover event 342 portion is greater than a low frequency peak 354 of the low frequency plot 350. Similarly, a high frequency trough 356 of the high frequency plot 348 is lower than a low frequency trough 358 of the low frequency plot 350. This may be because of the greater data resolution of the high frequency data stream used to generate the high frequency plot 348. In this manner, the breakover identification and analysis engine may more consistently and/or more accurately identify the occurrence of and/or the magnitude of a breakover event.

As discussed herein, the breakover identification and analysis engine may generate a confidence score for the identification of the breakover event. The breakover identification and analysis engine may generate the confidence score based at least in part on the number of datapoints used to identify the breakover event. For example, the breakover identification and analysis engine may calculate the breakover event using a half-cycle. The half-cycle may be defined by the movement state. In some embodiments, the half-cycle may be defined by the period from first motion (e.g., the trigger event 341), through the first peak (e.g., the high frequency peak 352 or the low frequency peak 354) and to the first rough (e.g., the high frequency trough 356 or the low frequency trough 358). A higher number of datapoints within the half-cycle may result in a greater confidence score. As a specific, non-limiting example, a half-cycle having greater than 7 datapoints may generate a high confidence score, a half-cycle having 6 or 7 datapoints may generate a medium confidence score, a half-cycle having 4 or 5 datapoints may generate a low confidence score, and a half-cycle having 3 or fewer datapoints may generate a poor confidence score. In the embodiment shown, the low frequency plot 350 has a poor confidence score because the half-cycle has three datapoints between the trigger event 341 and the low frequency trough 358. The high frequency plot 348 has more than 7 datapoints in the half-cycle between the trigger event 341 and the high frequency trough 356, with an associated high confidence score.

In accordance with at least one embodiment of the present disclosure, the breakover identification and analysis engine may identify when the drilling system enters the steady state motion 344. For example, the breakover identification and analysis engine may identify when the breakover event is completed and identify the steady state based on the completion of the breakover event. In some embodiments, the breakover identification and analysis engine may identify steady state motion 344 based on when the variance in sensor measurements are within a threshold range. In some embodiments, identifying the steady state motion 344 may facilitate quantification of the magnitude of the breakover event. In some embodiments, this may facilitate automation of the system. In some embodiments, identification of the steady state motion 344 immediately following the breakover event may have improved accuracy as friction on the drill string may change over time.

FIG. 3-2 is a representation of a second breakover profile 338-2 representing of a first downward movement state. In the second breakover profile 338-2 illustrated, in the static state 340, the drill string is not moving. At a trigger event 341, the drill string has experienced movement in a breakover event 342. After the breakover event 342, the drill string may enter steady state motion 344.

The movement state may be identified by a movement state plot 346. The movement state plot 346 may be a representation of the movement state of the drill rig. Based on the movement state, a breakover identification and analysis engine may identify the occurrence of a breakover event based on the breakover event 342 portion of the second breakover profile 338-2.

The second breakover profile 338-2 includes a high frequency plot 348 and a low frequency plot 350 of hookload. As may be seen, a high frequency trough 356 of the high frequency plot 348 is lower than a low frequency trough 358 of the low frequency plot 350. Further, a high frequency peak 352 of the high frequency plot 348 is greater than a low frequency peak 354 of the low frequency plot 350. This may be because of the greater data resolution of the high frequency data stream used to generate the high frequency plot 348. In this manner, the breakover identification and analysis engine may more consistently and/or more accurately identify the occurrence of and/or the magnitude of a breakover event.

FIG. 3-3 is a representation of a third breakover profile 338-3 representing of a third rotational movement state. In the third breakover profile 338-3 illustrated movement is illustrated with respect to torque. In the static state 340, the drill string is not moving. At a trigger event 341, the drill string has experienced movement in a breakover event 342. After the breakover event 342, the drill string may enter steady state motion 344.

The movement state may be identified by a movement state plot 346. The movement state plot 346 may be a representation of the movement state of the drill rig. Based on the movement state, a breakover identification and analysis engine may identify the occurrence of a breakover event based on the breakover event 342 portion of the third breakover profile 338-3.

The third breakover profile 338-3 includes a high frequency plot 348 and a low frequency plot 350. As may be seen, a high frequency peak 352 of the high frequency plot 348 in the breakover event 342 portion is greater than a low frequency peak 354 of the low frequency plot 350. Similarly, a high frequency trough 356 of the high frequency plot 348 is lower than a low frequency trough 358 of the low frequency plot 350. This may be because of the greater data resolution of the high frequency data stream used to generate the high frequency plot 348. In this manner, the breakover identification and analysis engine may more consistently and/or more accurately identify the occurrence of and/or the magnitude of a breakover event.

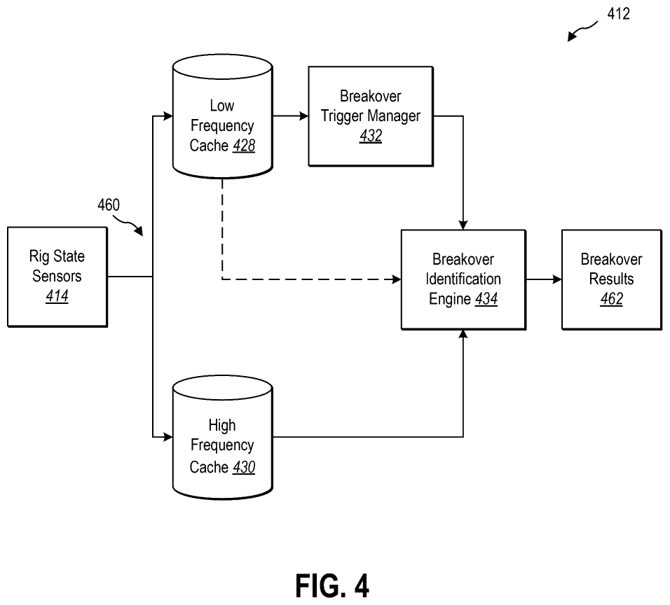

FIG. 3-4 is a representation of a fourth breakover profile 338-4 representing of a fourth upward followed immediately by downward movement state. In the fourth breakover profile 338-4 illustrated, in the static state 340, the drill string is not moving. At a trigger event 341, the drill string has experienced movement in a breakover event 342. After the breakover event 342, the drill string may enter steady state motion 344.

The movement state may be identified by a movement state plot 346. The movement state plot 346 may be a representation of the movement state of the drill rig. Based on the movement state, a breakover identification and analysis engine may identify the occurrence of a breakover event based on the breakover event 342 portion of the fourth breakover profile 338-4.

The fourth breakover profile 338-4 includes a high frequency plot 348 and a low frequency plot 350 of hookload. As may be seen, a high frequency peak 352 of the high frequency plot 348 in the breakover event 342 portion is greater than a low frequency peak 354 of the low frequency plot 350. Similarly, a high frequency trough 356 of the high frequency plot 348 is lower than a low frequency trough 358 of the low frequency plot 350. This may be because of the greater data resolution of the high frequency data stream used to generate the high frequency plot 348. In this manner, the breakover identification and analysis engine may more consistently and/or more accurately identify the occurrence of and/or the magnitude of a breakover event.

FIG. 4 is a schematic representation of a breakover management system 412, according to at least one embodiment of the present disclosure. The breakover management system 412 may include a plurality of rig sensors 414. The rig sensors 414 may generate a rig sensor data stream 460. The rig sensor data stream 460 may store a low frequency rig sensor data stream in a low frequency cache 428 and a high frequency rig sensor data stream in a high frequency cache 430. In some embodiments, different rig sensors 414 may generate the low frequency rig sensor data stream and the high frequency rig sensor data stream. In some embodiments, the same rig sensor data stream 460 may be used to generate the low frequency rig sensor data stream and the high frequency rig sensor data stream. For example, to generate the low frequency cache 428 having a monitoring frequency of 1 Hz, 1 measurement every second may be selected or stored in the low frequency cache 428. As discussed herein, the high frequency rig sensor data stream may have an analysis frequency that is the same as the measurement frequency of the rig sensor data stream 460. In this manner, the high frequency cache 430 may store all of the rig sensor data stream 460. In some embodiments, when the analysis frequency is lower than the measurement frequency, measurements may be collected from the rig sensor data stream 460 at the analysis frequency for storage in the high frequency cache 430.

A breakover trigger manager 432 may monitor the low frequency rig sensor data stream from the low frequency cache 428 to identify a trigger event. When the breakover trigger manager 432 identifies a trigger event, a breaker identification engine 434 may identify a breakover event from the rig sensor data stream 460. For example, the breaker identification engine 434 may retrieve the high frequency rig sensor data stream from the high frequency cache 430 to identify the breakover event from a breakover profile, thereby generating breakover results 462. In some embodiments, the breaker identification engine 434 may identify the breakover event using the low frequency rig sensor data stream from the low frequency cache 428.

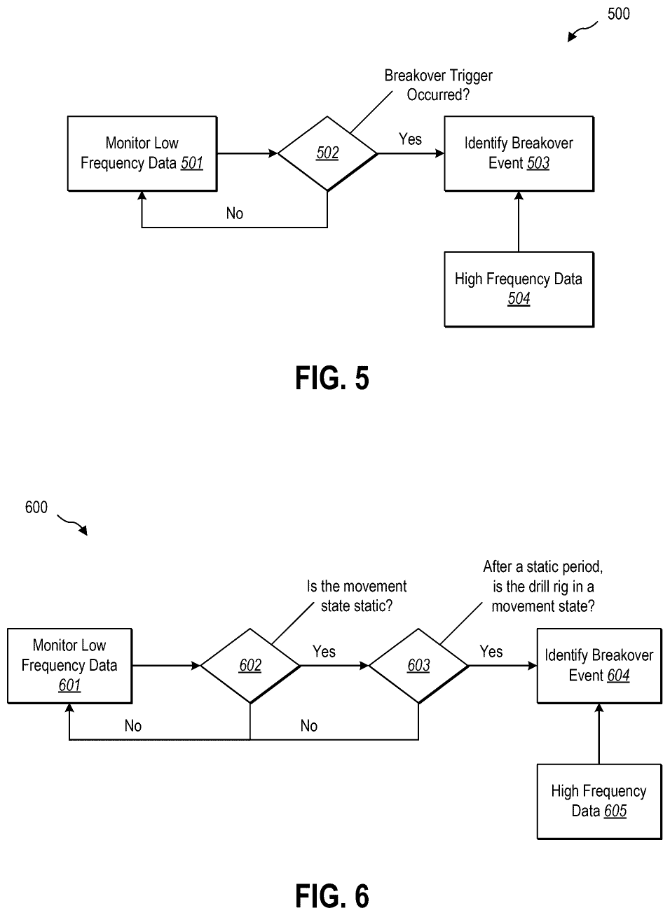

FIG. 5 through FIG. 8, the corresponding text, and the examples provide a number of different methods, systems, devices, and computer-readable media of the breakover management system 212. In addition to the foregoing, one or more embodiments can also be described in terms of flowcharts comprising acts for accomplishing a particular result, as shown in FIG. 5 through FIG. 8. FIG. 5 through FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method 500 for identifying a breakover event, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

A breakover management system may monitor low frequency rig sensor data stream and rig state calculations at 501. The breakover management system may determine 502 whether a breakover trigger event has occurred. When the breakover trigger event does not occurred, then the breakover management system may continue to monitor the low frequency rig sensor data stream. When the breakover trigger event does occur, then the breakover management system may identify a breakover event at 503. For example, as discussed herein, the breakover management system may identify the breakover event using a high frequency rig sensor data stream 504. In some embodiments, when the trigger event occurs, the breakover management system may analyze the rig sensor measurements with associated rig state determination and determine that no breakover has occurred. For example, and for various reasons, the drilling system may start moving after a period of motionlessness without triggering a breakover event. The breakover management may identify that a breakover event did not occur based on the breakover profile.

As mentioned, FIG. 6 illustrates a flowchart of a series of acts or a method 600 for identifying a potential breakover event, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

A breakover management system may monitor low frequency rig sensor data stream at 601. The breakover management system may determine 602 whether the movement state of drill rig is static. If the drill rig is not in a static state, the breakover management system may continue to monitor the low frequency rig sensor data stream. If the drill rig is in a static state, the breakover management system may determine 603 whether, after a static period, the drill rig is in a movement state (e.g., the four movement states discussed herein). If the drill rig is not in the movement state, the breakover management system may continue to monitor the low frequency rig sensor data stream. If the drill rig transitions to the movement state, the breakover management system may identify the potential breakover event at 604. The breakover management system may identify the breakover event using a high frequency rig sensor data stream 605. As discussed herein, in some embodiments, when the trigger event occurs, the breakover management system may analyze the rig sensor measurements with associated rig state determination and determine that no breakover has occurred. For example, and for various reasons, the drilling system may start moving after a period of motionlessness without triggering a breakover event. The breakover management may identify that a breakover event did not occur based on the breakover profile.

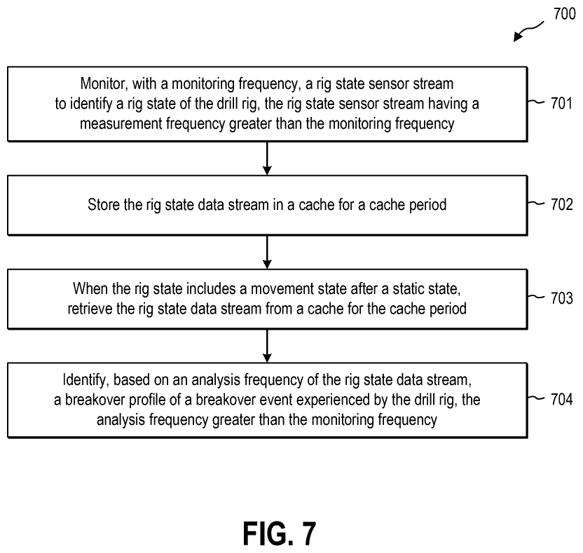

As mentioned, FIG. 7 illustrates a flowchart of a series of acts or a method 700 for identifying a breakover event, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. Alternatively, a computer-readable medium can comprise instructions that, when executed by one or more processors, cause a computing device to perform the acts of FIG. 7. In some embodiments, a system can perform the acts of FIG. 7.

A breakover management system may monitor, with a monitoring frequency, a rig sensor data stream to identify a rig state of the drill at 701. As discussed herein, the rig sensor data stream has a measurement frequency that is greater than the monitoring frequency of the rig sensor data stream. The breakover management system may store the rig sensor data stream in a cache for a cache period at 702. The breakover management system may, when the rig state includes movement after a static state, retrieve the rig sensor measurements with associated rig state determination from the cache for the cache period at 703. The breakover management system may identify, based on an analysis frequency of the rig sensor data stream, a breakover profile of a breakover event experienced by the drill rig at 704. The analysis frequency may be greater than the monitoring frequency.

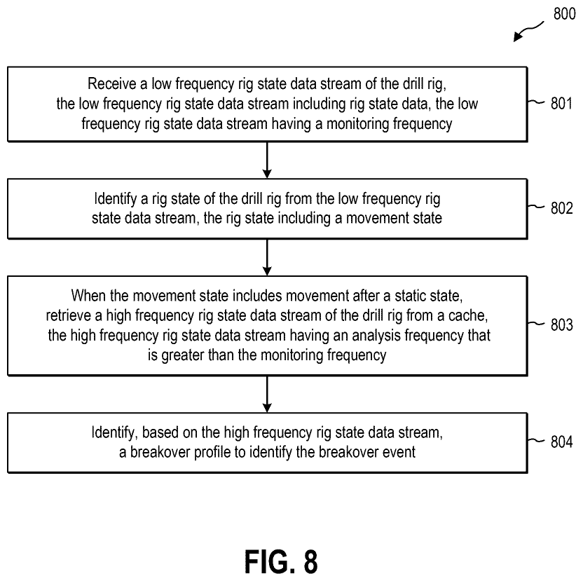

As mentioned, FIG. 8 illustrates a flowchart of a series of acts or a method 800 for identifying a breakover event, according to at least one embodiment of the present disclosure. While FIG. 8 illustrates acts according to one embodiment, alternative embodiments may omit, add to, reorder, and/or modify any of the acts shown in FIG. 8. The acts of FIG. 8 can be performed as part of a method. Alternatively, a computer-readable medium can comprise instructions that, when executed by one or more processors, cause a computing device to perform the acts of FIG. 8. In some embodiments, a system can perform the acts of FIG. 8.

A breakover management system may receive a lower frequency rig sensor data stream of a drill rig at 801. It should be understood that the terms “low frequency” and “high frequency” may refer to a relative frequency, with low frequency referring to measurements having a lower frequency than the high frequency measurements. The low frequency rig sensor data stream includes rig sensor measurements with associated rig state determination and has a monitoring frequency. The breakover management system identifies a rig state of the drill rig from the low frequency rig sensor data stream at 802. The rig state includes a movement state, pulled from the movement states discussed herein, including first movement upwards, first movement downwards, first movement rotation, and first movement upwards followed by movement downwards. When the movement state includes movement after a static state period, the breakover management system retrieves a high frequency rig sensor data stream of the drill rig from a cache at 803. The high frequency rig sensor data stream has an analysis frequency that is greater than the monitoring frequency. The breakover management system may identify, based on the high frequency rig sensor data stream, a breakover profile to identify the breakover event at 804.

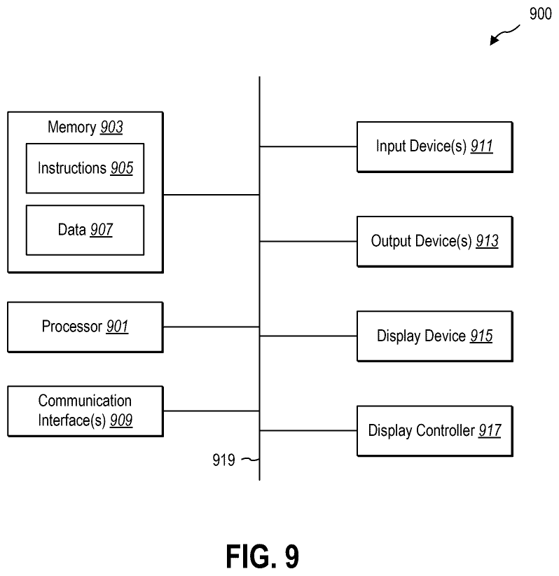

FIG. 9 illustrates certain components that may be included within a computer system 900. One or more computer systems 900 may be used to implement the various devices, components, and systems described herein.

The computer system 900 includes a processor 901. The processor 901 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

The embodiments of the breakover management system have been primarily described with reference to wellbore drilling operations; the breakover management systems described herein may be used in applications other than the drilling of a wellbore. In other embodiments, breakover management systems according to the present disclosure may be used outside a wellbore or other downhole environment used for the exploration or production of natural resources. For instance, breakover management systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for identifying a breakover event of a drill rig, the method comprising:
monitoring, with a monitoring frequency, a rig sensor data stream to identify a rig state of the drill rig, the rig sensor data stream having a measurement frequency greater than the monitoring frequency;
storing the rig sensor data stream in a cache for a cache period;
when the rig state includes a movement state after a static state, retrieving the rig sensor data stream from a cache for the cache period; and
identifying, based on an analysis frequency of the rig sensor data stream, a breakover profile of a breakover event experienced by the drill rig, the analysis frequency greater than the monitoring frequency.

2. The method of claim 1, wherein identifying the breakover profile is based on the movement state.

3. The method of claim 2, wherein identifying the breakover profile includes identifying a half-cycle of the breakover profile, the half-cycle defined by the movement state of the rig state.

4. The method of claim 1, wherein identifying the breakover profile includes identifying that breakover did not occur and that the drill rig is not experiencing differential sticking forces.

5. The method of claim 1, wherein the analysis frequency is based on a depth of the drill rig.

6. The method of claim 5, wherein the analysis frequency is greater than the monitoring frequency when the depth of the drill rig is less than 15,000 feet.

7. The method of claim 5, wherein analyzing the breakover profile includes identifying a formation property of a differential sticking zone at the depth of the drill rig.

8. The method of claim 1, wherein the monitoring frequency is approximately 1 Hz.

9. The method of claim 1, further comprising adjusting one or more of weight on bit or rotational rate of the drill rig based on the breakover profile.

10. The method of claim 1, wherein the cache period is between 25 and 30 seconds.

11. A method for identifying a breakover event of a drill rig, the method comprising:
receiving a low frequency rig sensor data stream of the drill rig, the low frequency rig sensor data stream including rig sensor measurements, the low frequency rig sensor data stream having a monitoring frequency;
identifying a rig state of the drill rig from the low frequency rig sensor data stream, the rig state including a movement state;
when the movement state includes movement after a static state, retrieving a high frequency rig sensor data stream of the drill rig from a cache, the high frequency rig sensor data stream having an analysis frequency that is greater than the monitoring frequency; and
identifying, based on the high frequency rig sensor data stream, a breakover profile to identify the breakover event.

12. The method of claim 11, further comprising:
receiving a rig sensor data stream from a plurality of sensors, the rig sensor data stream having a measurement frequency greater than the monitoring frequency;
generating the low frequency rig sensor data stream from the rig sensor data stream; and
generating the high frequency rig sensor data stream from the rig sensor data stream.

13. The method of claim 12, wherein generating the low frequency rig sensor data stream includes selecting individual measurements from the rig sensor data stream based on the monitoring frequency.

14. The method of claim 11, wherein identifying the breakover profile includes identifying the breakover profile based on the movement state.

15. The method of claim 14, wherein the breakover profile is different based on the movement state.

16. The method of claim 14, wherein identifying the breakover profile includes identifying a half-cycle of the breakover profile defined by the movement state.

17. The method of claim 16, further comprising generating a confidence score for the breakover event, the confidence score based on a number of datapoints within the half-cycle.

18. A drilling system, comprising:
a plurality of rig sensors that measure a rig sensor data stream with a measurement frequency; and
a processor and memory, the memory including instructions that cause the processor to:
monitor, with a monitoring frequency, the rig sensor data stream to identify a rig state of a drill rig, the measurement frequency greater than the monitoring frequency;
store the rig sensor data stream in a cache of the memory for a cache period;
when the rig state includes a movement state after a static state, retrieve the rig sensor data stream from a cache for the cache period; and
identify, based on an analysis frequency of the rig sensor data stream, a breakover profile of a breakover event experienced by the drill rig, the analysis frequency greater than the monitoring frequency.

19. The drilling system of claim 18, wherein identifying the breakover profile is based on the movement state.

20. The drilling system of claim 19, wherein identifying the breakover profile includes identifying a half-cycle of the breakover profile, the half-cycle defined by the movement state of the rig state.
